(19) United States
(12) Patent Application Publication
(10) Pub. No.: US 2024/0059181 A1
(43) Pub. Date: Feb. 22, 2024

(54) VEHICLE POWER SOURCE CONTROL SYSTEM AND METHOD

(71) Applicant: JAGUAR LAND ROVER LIMITED, Whitley, Coventry, Warwickshire (GB)

(72) Inventors: Gary EDWARDS, Coventry (GB); Richard LIGGATT, Coventry, West Midlands (GB); Stephen PICKERING, Coventry (GB)

(21) Appl. No.: 18/037,026

(22) PCT Filed: Nov. 12, 2021
(86) PCT No.: PCT/EP2021/081581

§ 371 Date: May 15, 2023

(30) Foreign Application Priority Data
Nov. 13, 2020 (GB) 2017903.2

(51) Int. Cl. B60L 58/13; B60L 50/15; B60L 50/61

(52) U.S. Cl. CPC B60L 58/13; B60L 50/15; B60L 50/61; B60L 2240/54; B60L 2250/12; B60L 2260/54

(57) ABSTRACT

A control system (400) is provided for an electrical power source (300) in a vehicle (100) having a driving system and a non-driving system. The control system (400) comprises one or more controller (420) configured to receive an extended power request associated with the non-driving system, determine an adjusted charging limit in dependence on a regular charging limit and the extended power request, and output a charge signal to charge the electrical power source (300) to the adjusted charging limit.

### TECHNICAL FIELD

The present disclosure relates to a control system for an electrical power source in a vehicle having a driving system and a non-driving system. The present disclosure further relates to a method for controlling an electrical power source in a vehicle having a driving system and a non-driving system.

### BACKGROUND

Vehicles, such as cars, generally comprise an electrical power source that serves to power at least part of the vehicle driving system. For the purpose of this patent application, all vehicle functionality that is needed for safely and legally driving the vehicle is considered to be part of the vehicle driving system. For an electric or hybrid vehicle, the driving system comprises the motor or motors driving the drivetrain. For the same and other vehicles, this functionality may further comprise powering, e.g., a starter motor or brake and steering assistance systems. Traditionally, lead acid batteries have been used for providing the necessary electrical power for the driving system. An alternator is usually provided for charging the battery while the engine is running.

In addition to the driving system, most vehicles have a non-driving system too. The non-driving system, e.g., comprises on-board entertainment systems, lighting provided solely for the convenience of the passengers, USB charging ports for mobile phones and other electronic equipment, and power outlets for all kinds of electrical devices. For example, the user may want to use the vehicle's electrical power source for powering a small fridge or an electric drill.

Some functionality, such as for example the legally required vehicle's exterior lighting may be considered to be part of either the driving system or the non-driving system. Alternatively, such lighting can be considered to be an essential part of the driving system while driving, but part of the non-driving system when the vehicle is parked and the lighting is used for the user's convenience only.

The non-driving system may be powered by the same lead acid battery as the driving system. However, this brings the risk of the lead acid battery regularly getting into a low charge state which is disadvantageous for the long-term functioning of the battery. Additionally, there is a risk that the battery is fully depleted by the non-driving system, thereby making it impossible to provide sufficient power to the starter motor to start the engine, recharge the battery and drive the vehicle.

To avoid such problems, a control system may monitor the charge status of the battery and warn or force the user to stop using the non-driving system when the charge status of the battery drops below a certain level. In some modern cars, the non-driving system is at least partially powered by a rechargeable lithium ion battery that is charged by the primary lead acid battery while driving. When the car is not driving, the lithium ion battery can be fully depleted, without risking any of the problems associated with depleting the lead acid battery. While both these solutions may help to avoid problems with starting the engine after prolonged used of the non-driving system, they do limit the amount of power available for the non-driving activities. Consequently, most power source and power source control systems are either designed for delivering moderate amounts of power that are only sufficient in the more common use scenarios or are over-designed to be able to deal with larger and uncommon power requirements. Therefore the power source cannot be used as desired or is more heavy and expensive than the user may like.

It is an aim of the present invention to address one or more of the disadvantages associated with prior art.

### SUMMARY OF THE INVENTION

Aspects and embodiments of the invention provide a control system for an electrical power source in a vehicle having a driving system and a non-driving system. Further aspects and embodiments of the invention provide a method for controlling an electrical power source in a vehicle having a driving system and a non-driving system, and a non-transitory computer readable medium.

According to an aspect of the present invention, a control system is provided for an electrical power source in a vehicle having a driving system and a non-driving system. The control system comprises one or more controller configured to receive an extended power request associated with the non-driving system, determine an adjusted charging limit in dependence on a regular charging limit and the extended power request, and output a charge signal to charge the electrical power source to the adjusted charging limit.

With this control system, an opportunity arises to prepare the power system for an incidental heavy task requiring more battery power, without having to over-design the system. For many batteries, especially for lithium ion batteries, repeated charging to full capacity leads to a reduced lifetime and charging capacity of the battery. Consequently, when charging the battery, the charge is typically terminated when the charge current drops below a threshold of, e.g., 3% of the initial charge current. According to the invention, upon receiving the extended power request, the control system may cause the battery to be charged to a level closer to its theoretical maximum charge level. Because this additional charging is only possible upon a specific request which may be granted only under specific circumstances, the power control system according to the invention is capable of delivering additional power when needed without requiring bigger, heavier and more expensive batteries and without significantly reducing the lifetime of the battery.

The extended power request may comprise a user-submitted extended power request, for example the user may submit such an extended power request using a user interface when they expect to use more electrical power than usual for a non-driving system.

Generally, the adjusted charging limit is higher than the regular charging limit. However, the same control system can also be used to temporarily lower the charging limit. The extended power request may, e.g., define an amount of requested additional power. Alternatively, the extended power request may define a power request period indicative of an amount of time during which a user wants the non-driving system to be powered. The control system may then determine, e.g., a maximum state of charge or a minimum charge current in dependence on the received amount of requested additional power or power request period.

In some embodiments, the one or more controllers collectively may comprise at least one electronic processor having an electrical input for receiving the extended power request; and at least one memory device electrically coupled to the at least one electronic processor and having instructions stored therein, and wherein the at least one electronic processor is configured to access the at least one memory device and execute the instructions thereon so as to determine the adjusted charging limit and to output the charge signal.

In some embodiments, a power extension record is retained comprising data concerning charging limit adjustments, and the adjusted charging limit is determined in dependence on the power extension record. For example, the control system may add the received power request and/or the adjusted charging limit to the power extension record. Because frequent charging above the regular charging limit may be detrimental to the long-term performance of the power source, the control system may, e.g., require a minimum amount of time or charging cycles between granting two requests for extended power. Alternatively, the control system may only allow a predetermined number of power requests per week, month or 100 charging cycles. If the charging limit adjustments vary in size, this can also be considered when determining to grant or partially grant an extended power request.

Additionally, the control system may be configured to output a signal to deliver electrical power to the driving system. Of course, this will happen if the driving system and the non-driving system together use only one power source. For example, all electrical systems may be powered by a lead acid battery that is charged by a running internal combustion engine. When more power is needed than usual, the battery will be charged up to the adjusted charging limit. When the driving system and the non-driving system use separate power sources, e.g. a lead acid battery and a lithium ion battery respectively, the power source for the non-driving system may be used for powering parts of the driving system in the event that the power source for the driving system is depleted or otherwise dysfunctional.

The driving system may, e.g., include a starter motor, and may be configured to output a signal to deliver electrical power to the starter motor. The control system may be configured to monitor a current state of charge, and to output a signal to deliver electrical power to the non-driving system only when the current state of charge exceeds a depletion limit. This ensures that there will always be enough electrical energy available for starting the engine. In a special embodiment, the control system is configured to output a signal to deliver electrical power to the driving system when the current state of charge is below the depletion limit. For example, the electrical power source may be used to start the engine and thereby allow recharging of the electrical power source to a state of charge level that will allow the user to use the non-driving system again.

The electrical power source may a battery, such as a lithium ion battery. The battery may be a 12V battery.

According to a further aspect of the invention, a vehicle and an electrical power source for a vehicle are provided, the electrical power source comprising a control system as described above.

According to a further aspect of the invention, a method is provided for controlling an electrical power source for a vehicle having a driving system and a non-driving system. The method comprises receiving an extended power request associated with the non-driving system, determining an adjusted charging limit in dependence on a regular charging limit and the extended power request, and outputting a signal to charge the electrical power source to the adjusted charging limit.

A non-transitory computer readable medium is provided, comprising computer readable instructions that, when executed by a processor, cause performance of this method.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 schematically shows a vehicle with a control system according to the invention.

FIG. 2 shows a simplified example of a control system such as may be adapted in accordance with an embodiment of the invention.

FIG. 3 illustrates a simplified flowchart of an example of a method for controlling an electrical power source for a vehicle having a driving system and a non-driving system.

### DETAILED DESCRIPTION

A control system for a vehicle in accordance with an embodiment of the present invention is described herein with reference to the accompanying figures.

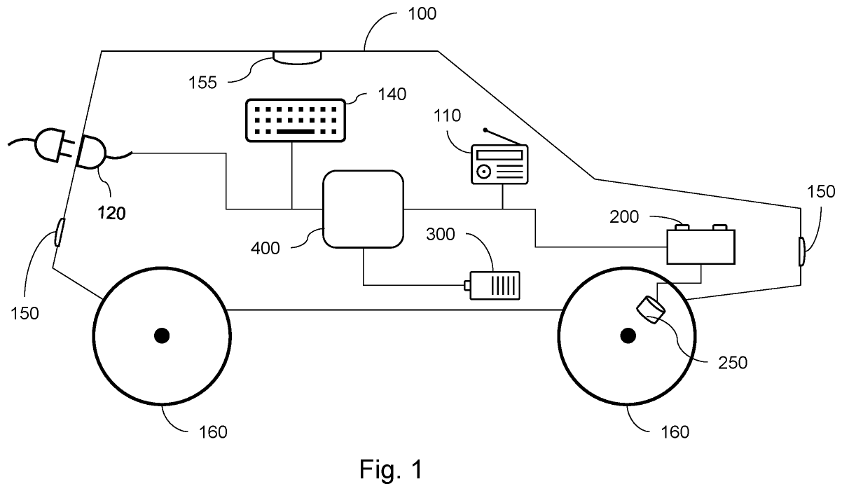

FIG. 1 schematically shows a vehicle 100 with a control system 400 according to the invention. The vehicle 100 comprises a primary electrical power source in the form of a lead acid battery 200 and a secondary electrical power source in the form of a lithium ion battery 300. In alternative embodiments, other types or a different number of electrical power sources may be used. For example, both the primary and the secondary power sources may be lithium ion batteries, a third electrical power source may be added, or the vehicle may only comprise a single high capacity battery providing the primary and secondary power sources. It the example of the single battery, the battery may comprise a plurality of a plurality of mutually coupled cells, each coupled to form the primary or secondary power source, and may be a lithium ion battery.

At least one of the electrical power sources, in this example the lead acid battery 200, may be charged by an alternator 250 that is coupled to an engine, a motor, one of the vehicle wheels 160 or another part of the drivetrain that rotates when the vehicle 100 is driving. When the vehicle 100 is an electric vehicle or a plug-in hybrid, one or more of the electrical power sources may be charged when the vehicle 100 is parked, via an electrical connection to a power grid. The primary and secondary electrical power sources may provide similar or different power outputs. In this example, the lead acid battery 200 and the lithium ion battery 300 are both 12V batteries.

In the vehicle 100 of FIG. 1, the lead acid battery is primarily or exclusively used to power the vehicle's driving system. For the purpose of this patent application, all vehicle functionality that is needed for safely and legally driving the vehicle is considered to be part of the vehicle driving system. For an electric or hybrid vehicle, the driving system comprises the motor or motors driving the drivetrain. For the same and other vehicles, this functionality may further comprise powering, e.g., a starter motor or brake and steering assistance systems. The lithium ion battery 300 is primarily or exclusively used for the vehicle's non-driving system. The non-driving system, e.g., comprises on-board entertainment systems 110, interior lighting 155 provided solely for the convenience of the passengers, USB charging ports for mobile phones and other electronic equipment, and power outlets 120 for all kinds of electrical devices. For example, the user may want to use the vehicle's electrical power source for powering a small fridge or an electric drill. Some functionality, such as for example the legally required vehicle's exterior lighting 150 may be considered to be part of either the driving system or the non-driving system. Alternatively, such lighting 150 can be considered to be an essential part of the driving system while driving, but part of the non-driving system when the vehicle 100 is parked and the exterior lighting 150 is used for the user's convenience only.

The charging and discharging of the electrical power sources is controlled by a control system 400. A user interface 140 may be coupled to the control system 400 to allow the user to monitor and control the control the control system 400. In a normal mode of operation, the lead acid battery 200 is charged by the alternator 250 while the vehicle 100 is driving and the lead acid battery 200 charges the lithium ion battery 300 up to a regular charging limit. While driving, the non-driving system may be powered by either of the two or both electrical power supplies. When the vehicle 100 is stopped or parked, the user may want to continue to use, e.g. an onboard entertainment system 110, indoor lighting 155 or a power outlet 120. In this embodiment, these and other parts of the non-driving system are powered by the lithium ion battery 300, at least while the vehicle 100 is not driving.

Because the lead acid battery 200 is not used while the vehicle is not driving, the lithium ion battery 300 can be used to power the non-driving system until the battery 300 is depleted. Alternatively, the battery 300 is only depleted up to a predetermined regular depletion limit. The depletion limit may, e.g., make it possible to use the lithium ion battery 300 for an emergency start-up of the engine when the lead acid battery 200 fails. Further, not fully depleting the lithium ion battery 300 may help to increase its lifetime and maintain a higher storage capacity over a longer period of time. The depletion limit may have two or more different trigger levels. At a first, higher, depletion level, the user may be warned that the battery 300 is running out of power and needs to be recharged. When the user then continues to use the non-driving system, possibly after actively confirming this via the user interface 140, the battery 300 can still be used until the second, lower, depletion level is reached.

Similarly, lithium ion batteries are generally not charged to full capacity because doing so repeatedly will significantly reduce its lifetime and storage capacity. Therefore, in a regular charging cycle, the control system 400 controls the charging process to make the lead acid battery 200 charge the lithium ion battery up to the regular charging limit only. However, in accordance with the invention, the user gets the opportunity to use the user interface 140 to submit an extended power request. The user may submit such a request when he expects to use more electrical power than usual for the non-driving system. This may, e.g., be the case during a camping trip or when planning to use the power outlet 120 for a prolonged period of time. The extended power request may be a simple indication that more power is desired and the control system 400 may then adjust the charging limit to a predetermined adjusted charging limit. The system may allow the user to define an amount of additional power the user would like to have available. An amount of additional power will typically be defined in Wh (watt-hour), but the user may be allowed to indicate an amount of additional time he wants to use the non-driving system, or to choose between two or more discrete options, e.g. labelled ‘more’ and ‘much more’. The control system 400 will then convert the user instructions to an actual amount of additional power and will charge the battery 300 to the adjusted charging limit.

Since repeatedly charging the lithium ion battery 300 over the regular charging limit may damage the battery 300 and reduce its lifetime, the control system 400 may be configured not to accept just any request for extended power. For example, the control system 400 may store a power extension record comprising data concerning charging limit adjustments. When receiving an extended power request, the adjusted charging limit is then determined in dependence on the power extension record. For example, the control system 400 may add the received power request and/or the adjusted charging limit to the power extension record. The control system 400 may then, e.g., require a minimum amount of time or charging cycles between granting two requests for extended power. Alternatively, the control system may only allow a predetermined number of power requests per week, month or 100 charging cycles. If the charging limit adjustments vary in size, this can also be considered when determining to grant or partially grant an extended power request.

Similarly, the possibility to deplete the battery 300 beyond the first depletion level is only limitedly available too. For example, this possibility may be available once every 5 or 10 charging cycles, only once a month or week, or only 10, 20 or 50 times during the lifetime of the battery 300. For this purpose, the power extension record may be supplemented with information about when the battery 300 is depleted beyond its first depletion level. Optionally, the power extension record may further comprise data concerning the temporarily adjusted depletion limits. Adjustments to the charging limit may, but not have to, be linked to adjustments of the depletion limit. The adjustment of the depletion limit brings the advantage that it may still be requested when the vehicle 100 already stopped driving and the user is already using the non-driving system. Adjustments of the charging limit are to be requested before or while charging the battery 300.

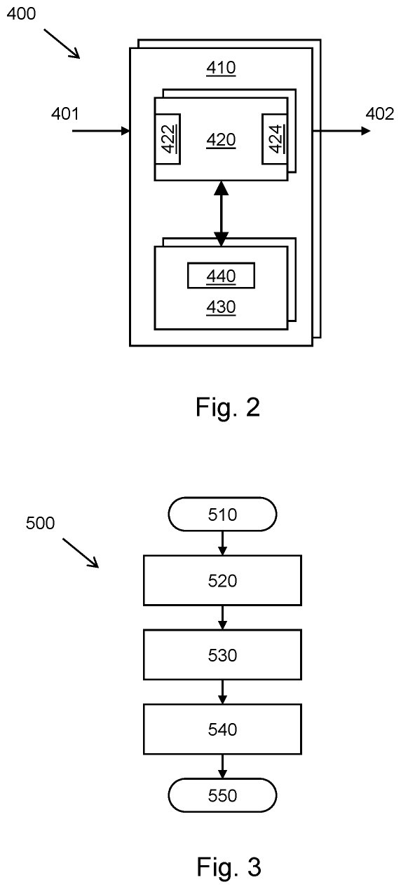

FIG. 2 shows a simplified example of a control system 400 such as may be adapted in accordance with an embodiment of the invention. The control system 400 may comprises one or more controllers 410. It is to be understood that the or each controller 410 can comprise a control unit or computational device having one or more electronic processors (e.g., a microprocessor, a microcontroller, an application specific integrated circuit (ASIC), etc.), and may comprise a single control unit or computational device, or alternatively different functions of the or each controller 410 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller 410 to implement the control techniques described herein (including some or all of the functionality required for the method described herein). The set of instructions could be embedded in said one or more electronic processors of the controller 410; or alternatively, the set of instructions could be provided as software to be executed in the controller 410. A first controller or control unit may be implemented in software run on one or more processors. One or more other controllers or control units may be implemented in software run on one or more processors, optionally the same one or more processors as the first controller or control unit. Other arrangements are also useful.

In the example illustrated in FIG. 2, the or each controller 410 comprises at least one electronic processor 420 having one or more electrical input(s) 422 for receiving one or more input signal(s) 401, such as those described above and one or more electrical output(s) 424 for outputting one or more output signal(s) 402. The or each controller 410 further comprises at least one memory device 430 electrically coupled to the at least one electronic processor 420 and having instructions 440 stored therein.

The, or each, electronic processor 420 may comprise any suitable electronic processor (e.g., a microprocessor, a microcontroller, an ASIC, etc.) that is configured to execute electronic instructions. The, or each, electronic memory device 430 may comprise any suitable memory device and may store a variety of data, information, threshold value(s), lookup tables or other data structures, and/or instructions therein or thereon. In an embodiment, the memory device 430 has information and instructions for software, firmware, programs, algorithms, scripts, applications, etc. stored therein or thereon that may govern all or part of the methodology described herein. The processor, or each, electronic processor 420 may access the memory device 430 and execute and/or use that or those instructions and information to carry out or perform some or all of the functionality and methodology describe herein.

The at least one memory device 430 may comprise a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

Example controllers 410 have been described comprising at least one electronic processor 420 configured to execute electronic instructions stored within at least one memory device 430, which when executed causes the electronic processor(s) 420 to carry out the method as hereinbefore described. However, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc.

Referring now to FIG. 3, there is illustrated a simplified flowchart 500 of an example of a method for controlling an electrical power source for a vehicle having a driving system and a non-driving system according to embodiments of the present invention, such as may be carried by the electronic processor(s) 420 when executing instructions stored within the at least one memory device 430. The method starts at 510 and comprises receiving 520 an extended power request associated with the non-driving system; determining 530 an adjusted charging limit in dependence on a regular charging limit and the extended power request; and outputting 540 a signal to charge the electrical power source to the adjusted charging limit. The method then ends at 550.

It will be appreciated that various changes and modifications can be made to the present invention without departing from the scope of the present application.

1. A control system for an electrical power source in a vehicle having a driving system and a non-driving system, the control system comprising one or more controller configured to:
receive an extended power request associated with the non-driving system;
determine an adjusted charging limit in dependence on a regular charging limit and the extended power request; and
output a charge signal to charge the electrical power source to the adjusted charging limit.

2. A control system according to claim 1, wherein the adjusted charging limit is higher than the regular charging limit.

3. A control system according to claim 1, wherein the extended power request defines an amount of requested additional power and wherein the adjusted charging limit is determined in dependence on the amount of requested additional power.

4. A control system according to claim 1, wherein the extended power request defines power request period, indicative of an amount of time during which a user wants the non-driving system to be powered, and wherein the adjusted charging limit is determined in dependence on the power request period.

5. A control system according to claim 1, configured to retain a power extension record comprising data concerning charging limit adjustments, and wherein the adjusted charging limit is determined in dependence on the power extension record.

6. A control system according to claim 1, configured to output a signal to deliver electrical power to the driving system.

7. A control system according to claim 6, configured to monitor a current state of charge, and to output a signal to deliver electrical power to the non-driving system only when the current state of charge exceeds a depletion limit and/or to output a signal to deliver electrical power to the driving system when the current state of charge is below the depletion limit.

8. A control system according to claim 1, wherein the electrical power source comprises a battery.

9. A control system according to claim 8, wherein the battery is a 12V battery.

10. An electrical power source for a vehicle, the electrical power source comprising a control system as claimed in claim 1.

11. A vehicle comprising an electrical power source as claimed in claim 10.

12. A method for controlling an electrical power source for a vehicle having a driving system and a non-driving system, the method comprising:
receiving an extended power request associated with the non-driving system;
determining an adjusted charging limit in dependence on a regular charging limit and the extended power request; and
outputting a signal to charge the electrical power source to the adjusted charging limit.

13. A non-transitory computer readable medium comprising computer readable instructions that, when executed by a processor, cause performance of the method of claim 12.

14. A control system according to claim 5, wherein the control system is configured to add the received power request to the power extension record and/or add the adjusted charging limit to the power extension record.

15. A control system according to claim 6, wherein the driving system includes a starter motor, and wherein the control system is configured to output a signal to deliver electrical power to the starter motor.

16. A control system according to claim 8, wherein the battery is a lithium ion battery.
